(19) United States
(12) Patent Application Publication
(10) Pub. No.: US 2009/0044097 A1
(43) Pub. Date: Feb. 12, 2009

(54) REDLINED OUTPUTTING OPTIONS FOR PRODUCTIVITY APPLICATIONS

(75) Inventor: Paul Elseth, Washougal, WA (US)

Correspondence Address: ROPES & GRAY LLP, PATENT DOCKETING 39/361, 1211 AVENUE OF THE AMERICAS, NEW YORK, NY, 10036-8704, US

(73) Assignee: Apple Inc, Cupertino, CA (US)

(21) Appl. No.: 12/187,037

(22) Filed: Aug. 6, 2008

Related U.S. Application Data
(60) Provisional application No. 60/963,812, filed on Aug. 6, 2007.

(51) Int. Cl. G06F 17/24

(52) U.S. Cl. 715/233

(57) ABSTRACT

Systems, methods, and computer readable media for providing improved user interfaces for productivity applications are provided. In some embodiments, a user can output a clean copy of a document that has been edited using redlines while preserving the redlines in the open document.

### CROSS-REFERENCE TO RELATED CASES

This application claims the benefit of U.S. Provisional Patent Application No. 60/963,812, filed Aug. 6, 2007, which is hereby incorporated by reference herein in its entirety.

### FIELD OF THE INVENTION

This can relate to productivity applications and, more particularly, to systems, methods, and computer readable media for providing redlined outputting options for productivity applications.

### BACKGROUND OF THE DISCLOSURE

Productivity applications, such as word processing applications (e.g., Apple Inc.'s Pages™), database processing applications (e.g., Microsoft Corporation's Access™), spreadsheet applications (e.g., Microsoft Corporation's Excel™), lifestyle applications (e.g., Apple Inc.'s iTunes™, iDVD™, GrageBand™, iChat™, iWeb™, Aperture™, iPhoto™, etc.), just to list a few, are widely known and used to generate and/or interact with data. Redlining application features, which are often implemented in productivity applications to show changes made to a work product and comments attached therewith, such as changes made to the text of a word processing document, for example, are frequently used in the preparation of the work products, particularly when multiple authors collaborate to draft and/or edit the work product.

When working in a redlined document, for example, it is often desirable to have access to a “clean” copy, where the redlined edits or track changes are merged into the text (a process often referred to as “accepting” the redlined edits), while preserving the redlined version of the document for making further redline edits. While it is possible to generate a clean copy of a redlined document without permanent loss of the redlines, doing so generally involves the cumbersome process of manually directing the productivity application to accept the redlined changes, output the clean copy in the desired format (e.g., in printed form), and then undo the acceptance of the redlined changes, thereby restoring the redlined changes to the document.

In view of the foregoing, it would be desirable to have methods, systems, and computer readable media for providing one or more user interface features that permit a user to output a clean copy of a redlined document while preserving the redline edits.

### SUMMARY OF THE DISCLOSURE

Methods, systems, and computer readable media for providing redlined outputting options for productivity applications are provided.

For example, selection of one or more icons or menu options in a user interface of a productivity application can output a clean copy of a document that includes redlining. For example, the productivity application can (temporarily) store all redlined edits in a document, accept all redlined edits, output the document without the redlining, access the stored redlined edits, and automatically display the document with the redlined edits restored in the document.

In one embodiment, a method of outputting a redlined document, wherein the redlined document includes a set of redline edits, includes temporarily storing the set of redline edits in memory, accepting each redline edit of the set of redline edits, outputting a clean copy of the redlined document including each of the accepted redline edits, and restoring each redline edit of the stored set of redline edits in redline form in the redlined document.

In one embodiment, a system for outputting a redlined document, wherein the redlined document includes a set of redline edits, includes a memory, and a processor coupled to the memory, wherein the processor is configured to temporarily store the set of redline edits in the memory, accept each redline edit of the set of redline edits, output a clean copy of the redlined document including the accepted redline edits, and restore each redline edit of the set of redline edits stored in the memory in redline form in the document.

In one embodiment, a computer readable medium for outputting a redlined document, wherein the redlined document includes a set of redline edits, includes instructions for temporarily storing the set of redline edits in memory, accepting each redline edit of the set of redline edits, outputting a clean copy of the redlined document including each of the accepted redline edits, and restoring each redline edit of the stored set of redline edits in redline form in the redlined document.

In one embodiment, a system for outputting a redlined document, wherein the redlined document includes a set of redline edits, includes means for temporarily storing the set of redline edits in memory, means for accepting each redline edit of the set of redline edits, means for outputting a clean copy of the redlined document including each of the accepted redline edits, and means for restoring each redline edit of the stored set of redline edits in redline form in the redlined document.

### BRIEF DESCRIPTION OF THE DRAWINGS

The above and other advantages of the present invention will become more apparent upon consideration of the following detailed description, taken in conjunction with the accompanying drawings, in which like reference characters refer to like parts throughout, and in which:

FIG. 1 is a schematic diagram of a computer system that operates in accordance with an embodiment of the present invention;

FIG. 2 is a schematic diagram of a computer system that operates in accordance with an embodiment of the present invention; and

FIG. 3 is a flow chart illustrating an embodiment of a process for providing a user interface that allows a user to output a clean copy of a redlined document in accordance with an embodiment of the present invention.

### DETAILED DESCRIPTION OF THE DISCLOSURE

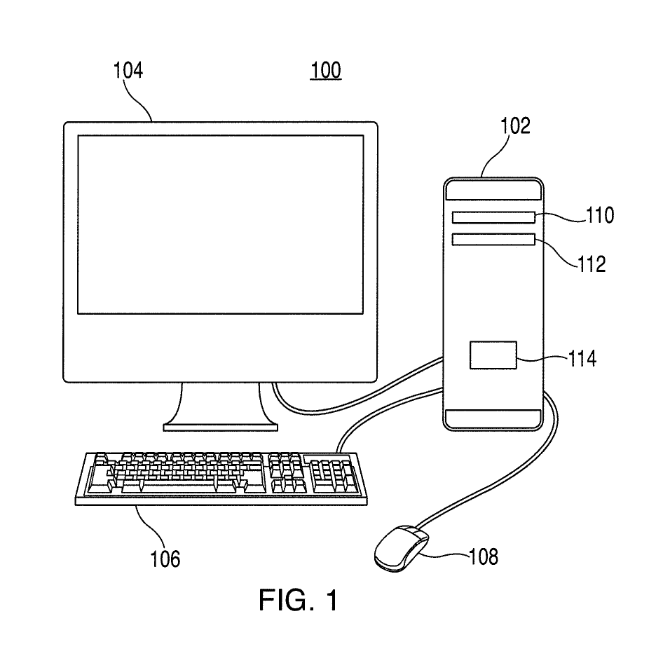

Systems, computer readable media, and methods for providing redlined outputting options for productivity applications are provided and described with reference to FIGS. 1-3.

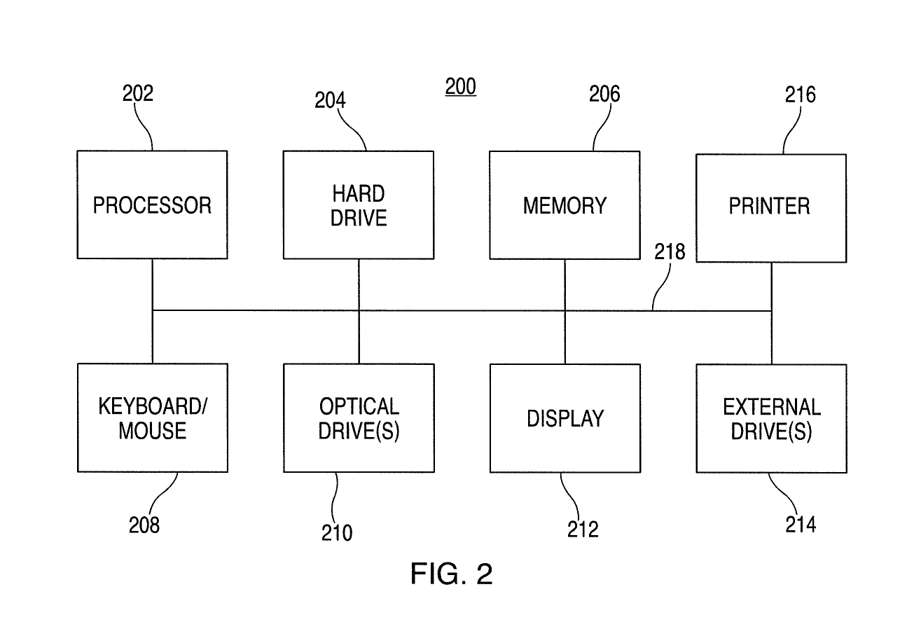

FIG. 1 shows a schematic diagram of a computer system 100, which can be operated in accordance with the principles of the present invention. Computer system 100 may include processor box 102, monitor 104, keyboard 106, and mouse 108. Processor box 102 may include various components, such as those described below with respect to FIG. 2, as well as optical drive 110 and optional optical drive 112. In addition, external drives, such as FLASH sticks or other such devices, may be connected to processor box 102 via one or more ports that are located, in this instance, on a section 114 of the front panel of processor box 102. As set forth in detail below, computer system 100 may be operated in accordance with the principles of the present invention in order to run productivity applications with user interfaces that provide features allowing a user to output a clean copy of a redlined document.

FIG. 2 shows computer system 200, which can be a further representation of computer system 100 of FIG. 1. Computer system 200 can include processor 202, hard drive 204, memory 206, keyboard/mouse 208, optical drive(s) 210, display 212, external drive(s) 214, and printer 216. For purposes of illustration, each of the components shown in FIG. 2 is shown coupled to one another via a single bus 218. Persons of ordinary skill in the art will appreciate that, for all practical purposes, computers are currently designed with multiple buses that are interfaced with each other. For example, keyboard/mouse 208 is typically connected to the computer via a USB connection (i.e., a universal serial bus), while the processor and memory communicate via a separate, high-speed bus. Computer system 200 may be operated in accordance with the principles of the present invention in order to assist a user to run productivity applications with features allowing the user to output a clean copy of a redlined document.

Computer systems 100 and 200 are, in general, widely known. Productivity applications are run on computer systems and used to generate content having different types of information. Different productivity applications include, for example, word processing applications, spreadsheet applications, presentation applications, visual graphic applications (e.g., chart, graph, map, drawing, and image applications), audio applications, multimedia applications (e.g., video applications), and database applications. Productivity applications often have redlining application features to show changes made to a work product and comments attached therewith, such as changes made to the text of a word processing document, for example. Such redlining features are frequently used in the preparation of the work products, particularly when multiple authors collaborate to draft and/or edit the work product. However, when working in a redlined document, for example, it is often desirable to have access to a “clean” copy, where some or all of the redlined edits are merged into the text (a process often referred to as “accepting” the redlined edits), while preserving the redlined version of the document for making further redline edits.

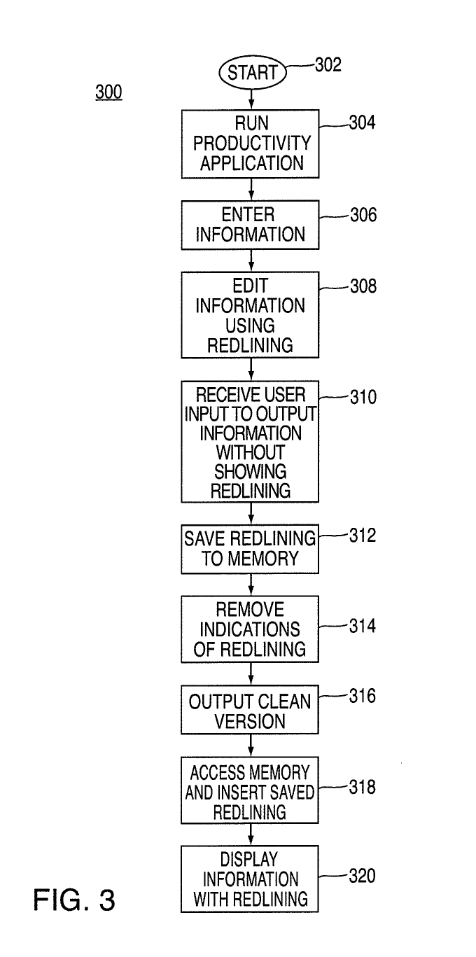

FIG. 3 is a flow chart illustrating an embodiment of a process 300 for providing a user interface that allows a user to output a clean copy of a redlined document in accordance with an embodiment of the invention.

At step 302, a productivity application may be initialized and, at step 304, the productivity application may be run. At step 306, information may be entered by a user. For example, the productivity application can be a word processing application and the information can be text information. At step 308, the information may be edited using redlining. Various types of information may be entered by a user at step 306 and/or edited using redlining at step 308. A user input can include inputting or editing information, which can take one of many forms, including, but not limited to, text information, visual graphic information (e.g., chart, graph, map, drawing, or image information), audio information, multimedia information (e.g., video information), XML (Extensible Markup Language) information, HTML (Hyper Text Mark-Up Language) information, XSL (Extensible Stylesheet Language) information, CSS (Cascading Style Sheet) information, and database information. A user input can also include changing a document's format settings, such as the page setup.

At step 310, the productivity application may receive a user input to output the information without showing the redlining. The user input can be of any known type, including, but not limited to, clicking an icon, making a menu selection, and typing a command in a command line. At step 312, the productivity application can cause the redline edits to be saved to memory (e.g., memory 206 of FIG. 2). At step 314, some (i.e., a subset) or all of the redline edits may be accepted into the information, and some or all indications of redlining may be removed or cleaned from the document. If only a subset of the redline edits are to be accepted and/or removed at step 314, the subset may be predetermined by the designer of the user interface or can be a custom subset of the redline edits as preselected by the user.

At step 316, the clean version of the document may be output. The output can be in any known document output type, including, but not limited to, a saved version, a printed version, and an e-mailed version.

In some embodiments, a user can be prompted before step 316 is executed to provide information related to the output (e.g., a file name for a saved version, print properties for a printed version, or e-mail properties for an e-mailed version). Also, in some embodiments, a user may not be prompted before step 316 for information related to the output, and the information may be provided automatically by the productivity application.

At step 318, the productivity application may access memory and insert the saved redlining, thereby restoring the document to its appearance at step 310, prior to the user input. At step 320, the information may be displayed with all the redline edits in place.

The process described in process 300 can take place without user intervention or direction after step 310 (except, as noted above, for embodiments where a file name is requested, for example). This can provide greater efficiency than prior art methods.

While preferred illustrative embodiments of the invention are described above, it will be apparent to one skilled in the art that various changes and modifications can be made therein without departing from the invention. The appended claims are intended to cover all such changes and modifications that fall within the true spirit and scope of the invention.

What is claimed is:

1. A method of outputting a redlined document, wherein the redlined document includes a set of redline edits, the method comprising:
temporarily storing the set of redline edits in memory;
accepting each redline edit of the set of redline edits;
outputting a clean copy of the redlined document including each of the accepted redline edits; and
restoring each redline edit of the stored set of redline edits in redline form in the redlined document.

2. The method of claim 1, wherein the outputting the clean copy of the redlined document comprises saving the clean copy of the redlined document.

3. The method of claim 2, further comprising prompting a user for a file name for the document before saving the clean copy of the redlined document.

4. The method of claim 2, further comprising assigning a file name for the document before saving the clean copy of the redlined document.

5. The method of claim 1, wherein the outputting the clean copy of the redlined document comprises printing the clean copy of the redlined document.

6. The method of claim 5, further comprising prompting a user for print settings for the document before printing the clean copy of the redlined document.

7. The method of claim 5, further comprising using predetermined print settings for the document before printing the clean copy of the redlined document.

8. The method of claim 1, wherein the outputting the clean copy of the redlined document comprises e-mailing the clean copy of the redlined document.

9. The method of claim 8, further comprising prompting a user for e-mail settings for the document before e-mailing the clean copy of the redlined document.

10. A system for outputting a redlined document, wherein the redlined document includes a set of redline edits, the system comprising:
a memory; and
a processor coupled to the memory, wherein the processor is configured to temporarily store the set of redline edits in the memory, accept each redline edit of the set of redline edits, output a clean copy of the redlined document including the accepted redline edits, and restore each redline edit of the set of redline edits stored in the memory in redline form in the document.

11. The system of claim 10, wherein the processor is configured to output the clean copy of the redlined document by saving the clean copy of the redlined document to the memory.

12. The system of claim 11, wherein the processor is further configured to prompt a user for a file name for the clean copy of the redlined document before saving the clean copy of the redlined document to the memory.

13. The system of claim 11, wherein the processor is further configured to assign a file name for the clean copy of the redlined document before saving the clean copy of the redlined document to the memory.

14. The system of claim 10, wherein the processor is configured to output the clean copy of the redlined document by causing the system to print the clean copy of the redlined document.

15. The system of claim 14, wherein the processor is further configured to prompt a user for print settings for the document before causing the system to print the clean copy of the redlined document.

16. The system of claim 14, wherein the processor is further configured to apply predetermined print settings for the document before causing the system to print the clean copy of the redlined document.

17. The system of claim 10, wherein the processor is configured to output the clean copy of the redlined document by e-mailing the clean copy of the redlined document.

18. The system of claim 17, wherein the processor is further configured to prompt a user for e-mail settings for the document before e-mailing the clean copy of the redlined document.

19. A computer readable medium for outputting a redlined document, wherein the redlined document includes a set of redline edits, the computer readable medium including instructions for:
temporarily storing the set of redline edits in memory;
accepting each redline edit of the set of redline edits;
outputting a clean copy of the redlined document including each of the accepted redline edits; and
restoring each redline edit of the stored set of redline edits in redline form in the redlined document.

20. The computer readable medium of claim 19, wherein the outputting a clean copy of the redlined document comprises saving the clean copy of the redlined document.

21. The computer readable medium of claim 20, further comprising prompting a user for a file name for the clean copy of the redlined document before saving the clean copy of the redlined document.

22. The computer readable medium of claim 20, further comprising assigning a file name for the clean copy of the redlined document before saving the clean copy of the redlined document.

23. The computer readable medium of claim 19, wherein the outputting the clean copy of the redlined document comprises printing the clean copy of the redlined document.

24. The computer readable medium of claim 23, further comprising prompting a user for print settings for the document before printing the clean copy of the redlined document.

25. The computer readable medium of claim 23, further comprising using predetermined print settings for the document before printing the clean copy of the redlined document.

26. The computer readable medium of claim 19, wherein the outputting the clean copy of the redlined document comprises e-mailing the clean copy of the redlined document.

27. The computer readable medium of claim 26, further comprising prompting a user for e-mail settings for the document before e-mailing the clean copy of the redlined document.

28. A system for outputting a redlined document, wherein the redlined document includes a set of redline edits, the system comprising:
means for temporarily storing the set of redline edits in memory;
means for accepting each redline edit of the set of redline edits;
means for outputting a clean copy of the redlined document including each of the accepted redline edits; and
means for restoring each redline edit of the stored set of redline edits in redline form in the redlined document.

29. The system of claim 28, wherein the means for outputting a clean copy of the redlined document comprises means for saving the clean copy of the redlined document.

30. The system of claim 29, further comprising means for prompting a user for a file name for the clean copy of the redlined document before saving the clean copy of the redlined document.

31. The system of claim 29, further comprising means for assigning a file name for the clean copy of the redlined document before saving the clean copy of the redlined document.

32. The system of claim 28, wherein the means for outputting the clean copy of the redlined document comprises means for printing the clean copy of the redlined document.

33. The system of claim 32, further comprising means for prompting a user for print settings for the document before printing the clean copy of the redlined document.

34. The system of claim 32, further comprising means for using predetermined print settings for the document before printing the clean copy of the redlined document.

35. The system of claim 28, wherein the means for outputting the clean copy of the redlined document comprises means for e-mailing the clean copy of the redlined document.

36. The system of claim 35, further comprising means for prompting a user for e-mail settings for the document before e-mailing the clean copy of the redlined document.
